(19) United States
(12) Patent Application Publication
(10) Pub. No.: US 2022/0015551 A1
(43) Pub. Date: Jan. 20, 2022

(54) Bedside portable bassinet

(71) Applicant: Susan Gopaul, BEAVERTON, OR (US)

(72) Inventor: Susan Gopaul, BEAVERTON, OR (US)

(21) Appl. No.: 16/929,201

(22) Filed: Jul. 15, 2020

(51) Int. Cl. A47D 9/00; B60B 33/06

(52) U.S. Cl. CPC A47D 9/005; B60B 33/06

(57) ABSTRACT

The present invention discloses a bassinet that can fold and unfold simply with a press of a button.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The invention relates to cribs and bassinets and, more particularly, relates to portable bassinets that can fold and open without assembling.

### Description of the Related Art

Bassinets provide a safe environment in which an infant child can rest. Typically, the bassinet is a child sleeping assembly that has a flat floor on which is a mattress pad with a fitted sheet. The child lies in the assembly. Usually a bassinet can accommodate a child until the child is about three months old. After this time the use of bassinets concludes hence there is a need that such bassinets can be transformed into different useful objects to be used for entire life of a child.

Virtually all of the furniture in a typical home or business is single-purpose, and a few pieces of furniture is such typical home or business are dual-purpose. Chairs and couches are used to sit on; beds to sleep, rest or otherwise recline; tables for work surfaces, or eating or meeting space; cabinets, shelves and drawers for storage or display.

Single-purpose furniture assemblies, and even some dual-purpose furniture assemblies, are not designed to be transformed into a multitude of separate, distinct furniture items. As a result, there is generally no utility to single or dual-purpose furniture assemblies beyond the singular or dual purpose for which they are designed. Typical household and office furniture items are not made to be disassembled and reassembled in numerous different configurations. Similarly, the individual components of typical household and office furniture items are not designed to be reutilized in an entirely different fashion.

When a piece of furniture is no longer of use, it is often stored, sold or discarded. Most of the stored furniture clutters storage areas such as attics, basements, garages, closets or rented off-site storage units. Most single and dual-purpose furniture is not easily disassembled for storage, consuming a large amount of expensive and scarce storage space.

j U.S. Patent Publication No. 2008/0222810. This device features a holding structure supported by a horizontal arm extending from a relatively sturdy support stand behind the head of the bed, or by a “C-shaped” apparatus which extends from below the bed upward, and over the adult bed area. The constructions shown are relatively bulky and likely expensive, and the overall ergonomic functioning leaves something to be desired.

Although the traditional bassinet can perform certain functions, the bed portion of the traditional bassinet is fixedly screwed to the cart and unable to be detached form the cart to use separately. In addition, the height adjustment of the traditional bassinet is awkward because a user has to operate four locking members (not shown) on the tubes to perform this height adjustment and this make the height adjusting very inconvenient.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The proposed invention is a Baby bassinet that can fold and open without assembling, it can adjust for any height such as adjacent to bed height. The proposed invention is a frame that holds a baby bassinet but can also be folded instantly without any tiresome joining components.

It can estimated that the bassinet can be folded in 20 seconds and requires 10 second to unfold which is the fastest for the bassinet to be in use from the prior art.

The stabilizing means and the crib can be detachably attached together for compactness and portability. The general idea of the invention is to provide quick access to a baby for nursing, comforting and changing without requiring the mother to get in and out of bed.

It is an object of the invention to provide improved elements and arrangements thereof for the purposes described which is inexpensive, dependable and fully effective in accomplishing its intended purposes.

It is another objective of the invention to provide a type of bassinet that is easily disassembled for packing and shipment without necessitating a bulky package and still is easily and quickly assembled.

It is further the objective to provide a bassinet in which an infant can be placed which is approximately the same size surface area as presently available with conventional bassinets.

A further object is to provide a bassinet with mounting arrangement which has a simple rigid construction and is detachable, portable and lightweight.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 shows full view of the proposed bassinet;

FIG. 200 is detailed view of proposed bassinet.

FIG. 300 show side view of the proposed bassinet.

FIG. 400 shows top view of the invention.

FIG. 500 shows another side view of the frame.

FIG. 600 shows button to release and to fold.

FIG. 700 shows inside view of the bassinet.

FIG. 800 shows folded view of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

One aspect of the present application is to provide a Baby bassinet that can be easily folded and resurrected using a button within a seconds without an extra effort to manipulate the assembly.

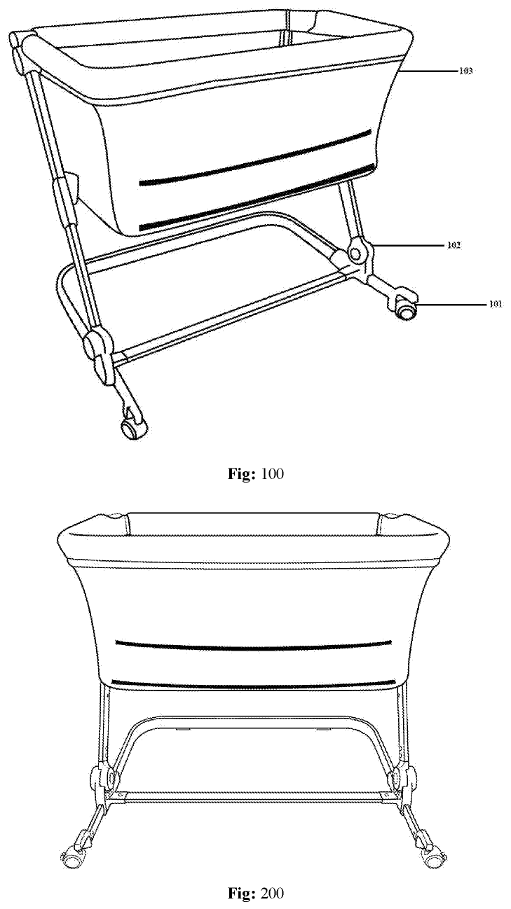

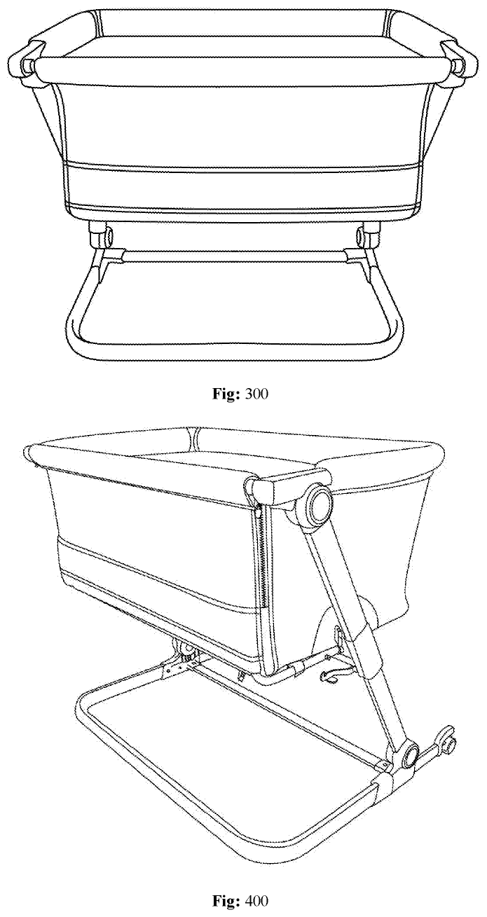

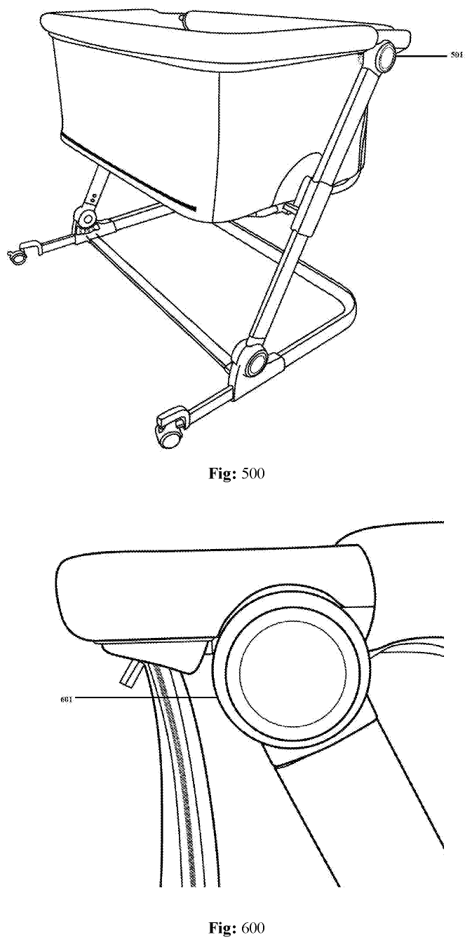

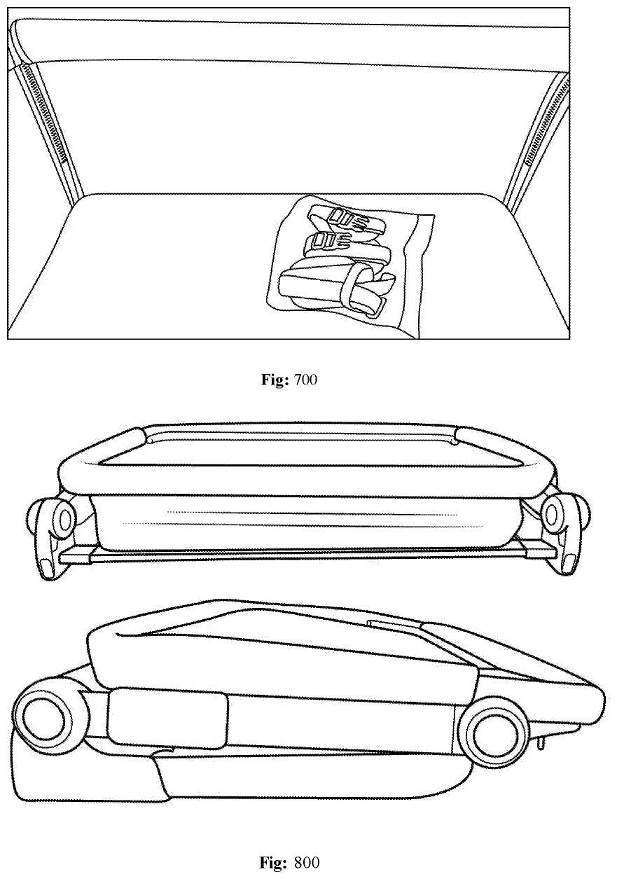

FIGS. 100, 200, 300, 400, 500, 600, 700, 800, 900 and 1000 illustrate an embodiment of the invention with parts showing instant function to fold and to unfold. FIG. 100 shows the bassinet with wheels 101, the folding hinge 102 and the bassinet seat 103. FIG. 500 shows the button 501 to be pressed to fold and to unfold the bassinet. FIG. 600 shows close view of the button 601.

The preferred embodiment of the present invention further comprises means for securing the end assemblies in the folded position, comprising assemblies and connected to one another to maintain the end assemblies in folded relationship. It can be seen that the present invention is folded to assume a unitary, generally narrow configuration that facilitates movement and storage of the folded bassinet. Further, the bassinet of the present invention can set up from a compact, unitary folded position into an open, usable position in a short period of time.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A bassinet that can fold and open without assembling, comprising:
a) a frame;
b) a button to release and to fold;
c) a bed for baby sleep; and
d) retractable wheel casters.

II: Each frame includes:
a) a lock receiver member;
b) Two legs;
c) Two brackets.

III: The invention further includes flexible operation and can be folded and un-folded with a press of a button.
